(19) United States
(12) Patent Application Publication
(10) Pub. No.: US 2025/0206081 A1
(43) Pub. Date: Jun. 26, 2025

(54) ACCOMMODATION BODY WITH FUNCTIONAL COMPONENT AND TIRE

(71) Applicant: THE YOKOHAMA RUBBER CO., LTD., Kanagawa (JP)

(72) Inventor: Masahiro NARUSE, Kanagawa (JP)

(21) Appl. No.: 18/848,350

(22) PCT Filed: Dec. 23, 2022
(86) PCT No.: PCT/JP2022/047510

§ 371 Date: Sep. 18, 2024

(30) Foreign Application Priority Data
Mar. 23, 2022 (JP) 2022-047066

(51) Int. Cl. B60C 23/04

(52) U.S. Cl. CPC B60C 23/0493

(57) ABSTRACT

A functional component to acquire tire information is housed by a housing body. The housing body includes a bottom fixed to a tire inner surface, a crown protruding from the bottom portion, a housing space formed by the bottom and the crown, and an opening communicating with the housing space. An inclination angle θ2 of the crown measured on an outer wall side of the crown in a state where the functional component is housed in the housing space with respect to the bottom is smaller than an inclination angle θ1 of the crown measured on the outer wall side of the crown in a state where the functional component is not housed in the housing space with respect to the bottom. An angle difference θ1−θ2 between the inclination angle θ1 and the inclination angle θ2 is in a range of 5 to 15°.

### TECHNICAL FIELD

The present technology relates to a housing body with a functional component and a tire and particularly relates to a housing body with a functional component and a tire that can prevent damage of the housing body housing the functional component while preventing the functional component from coming off during travel.

### BACKGROUND ART

A functional component (for example, a sensor unit including a sensor) configured to acquire tire internal information such as internal pressure or temperature is installed on a tire inner surface (see, for example, Japan Patent No. 6272225 B and Japan Unexamined Patent Publication No. 2016-505438 T). In installing the functional component, a housing body (container) made of rubber or the like is adhered to the tire inner surface, and the functional component is housed inside the adhered housing body. Unfortunately, when the functional component is not sufficiently restrained by the housing body in housing the functional component in the housing body, for example, when a large gap is present between the functional component and the housing body, the functional component may come off during travel. In addition, when the functional component is sufficiently restrained by the housing body but the restricting force is excessively large, for example, when the housing body is excessively deformed in a state where the functional component is housed, cracks may occur in the housing body during use.

### SUMMARY

The present technology provides a housing body with a functional component and a tire that can prevent damage of the housing body housing the functional component while preventing the functional component from coming off during travel.

A housing body with a functional component according to an embodiment of the present technology is a housing body with a functional component including a functional component configured to acquire tire information and a housing body housing the functional component. The housing body includes a bottom portion fixed to a tire inner surface, a crown portion protruding from the bottom portion, a housing space formed by the bottom portion and the crown portion, and an opening portion communicating with the housing space. An inclination angle of the crown portion measured on an outer wall side of the crown portion in a state where the functional component is housed in the housing space with respect to the bottom portion is smaller than an inclination angle of the crown portion measured on the outer wall side of the crown portion in a state where the functional component is not housed in the housing space with respect to the bottom portion. An angle difference between the inclination angles is in a range of 5 to 15°.

A tire according to an embodiment of the present technology includes the aforementioned housing body with a functional component fixed to the tire inner surface, and the functional component is housed in the housing space.

According to an embodiment of the present technology, the housing body with a functional component includes the functional component configured to acquire tire information and the housing body housing the functional component, the housing body includes the bottom portion fixed to the tire inner surface, the crown portion protruding from the bottom portion, the housing space formed by the bottom portion and the crown portion, and the opening portion communicating with the housing space, the inclination angle of the crown portion measured on the outer wall side of the crown portion in a state where the functional component is housed in the housing space with respect to the bottom portion is smaller than the inclination angle of the crown portion measured on the outer wall side of the crown portion in a state where the functional component is not housed in the housing space with respect to the bottom portion. This can prevent, in the housing body housing the functional component, excessive deformation of the housing body while ensuring the restricting force by which the functional component can be sufficiently restricted. In particular, when the angle difference between the inclination angles before and after the functional component is housed is in the range of 5° to 15°, an extremely good balance between the restricting force of the housing body with respect to the functional component and the degree of deformation at which the housing body is not damaged is provided. This can prevent the damage of the housing body while preventing the functional component from coming off during travel.

In the housing body with a functional component according to an embodiment of the present technology, the inclination angle of the crown portion measured on the outer wall side of the crown portion in a state where the functional component is housed in the housing space with respect to the bottom portion is preferably 90° or more. This can mitigate stress concentration at the base of the crown portion of the housing body and improve the durability of the housing body. Additionally, the opening portion of the housing body is not excessively narrow, which is suitable for removing the functional component.

The crown portion in which the functional component is housed in the housing space preferably has a thickness Ga of 1.0 mm to 3.5 mm. This can suppress the occurrence of cracks in the crown portion of the housing body and improve the durability of the housing body. In addition, when the thickness of the crown portion of the housing body is excessively large, the heat generation of the housing body increases. However, when the thickness Ga is within the range described above, the heat generation of the housing body can be suppressed, and damage of a housing of the functional component can be prevented.

The opening portion preferably has a width smaller than a minimum width of the housing space, and a circumferential length D2ᵤ of an upper portion of the housing space and a circumferential length D1ᵤ of an upper portion of the functional component preferably satisfy a relationship 0.60≤D2ᵤ/D1ᵤ≤0.95. This can increase the restricting force of the housing body with respect to the functional component and suppress the motion of the functional component, thus allowing damage of the housing of the functional component to be prevented during high-speed travel. In addition, a good balance between the restricting force of the housing body with respect to the functional component and the degree of deformation at which the housing body is not damaged is provided, thus allowing damage of the housing body to be also prevented.

An end portion of the crown portion preferably includes a locking portion bent toward the opening portion, and a height H1 of the functional component and a total inner height H2 of the housing body preferably satisfy a relationship 0.85≤H2/H1≤0.98. This provides a good balance between the restricting force of the housing body with respect to the functional component and the degree of deformation at which the housing body is not damaged and can improve the durability of the functional component during high-speed travel.

A circumferential length D2_{O} of the opening portion of the housing body and the circumferential length D1ᵤ of the upper portion of the functional component preferably satisfy a relationship 0.4≤D2_{O}/D1ᵤ≤0.8. This provides a good balance between the restricting force of the housing body with respect to the functional component and the degree of deformation at which the housing body is not damaged and can improve the durability of the functional component during high-speed travel. Additionally, the opening portion of the housing body is not excessively narrow, which is suitable for removing the functional component.

A modulus of the housing body at 100% elongation at 20° C. is preferably 0.5 MPa or more and less than 10.0 MPa, and a loss modulus of the housing body at 60° C. is preferably 0.4 MPa or more and less than 20.0 MPa. Appropriately setting the modulus as just described can provide the durability of the housing body and ease of housing the functional component in the housing body in a compatible manner. Appropriately setting the loss modulus as just described can prevent damage of the housing of the functional component due to rubbing of the functional component against the housing body or repeated deformation of the housing body.

The housing body is preferably made of vulcanized rubber. The housing body is preferably fixed to the tire inner surface with an adhesive.

The tire according to an embodiment of the present technology is preferably a pneumatic tire but may be a non-pneumatic tire. In a case of a pneumatic tire, the interior thereof can be filled with any gas including air and inert gas such as nitrogen.

### BRIEF DESCRIPTION OF DRAWINGS

FIGS. 1A to 1D illustrate an embodiment of a housing body with a functional component before and after the functional component is housed. FIG. 1A is a perspective view illustrating a state where the functional component is not housed, FIG. 1B is a cross-sectional view illustrating a state where the functional component is not housed, FIG. 1C is a perspective view illustrating a state where the functional component is housed, and FIG. 1D is a cross-sectional view illustrating a state where the functional component is housed.

FIGS. 2A to 2C are half cross-sectional views of the housing body with a functional component for describing the dimensions of the housing body.

FIG. 3 is a meridian cross-sectional view illustrating an embodiment of a pneumatic tire in which the housing body with a functional component is fixed to a tire inner surface.

FIG. 4 is an enlarged cross-sectional view illustrating the housing body with a functional component of FIG. 3.

### DETAILED DESCRIPTION

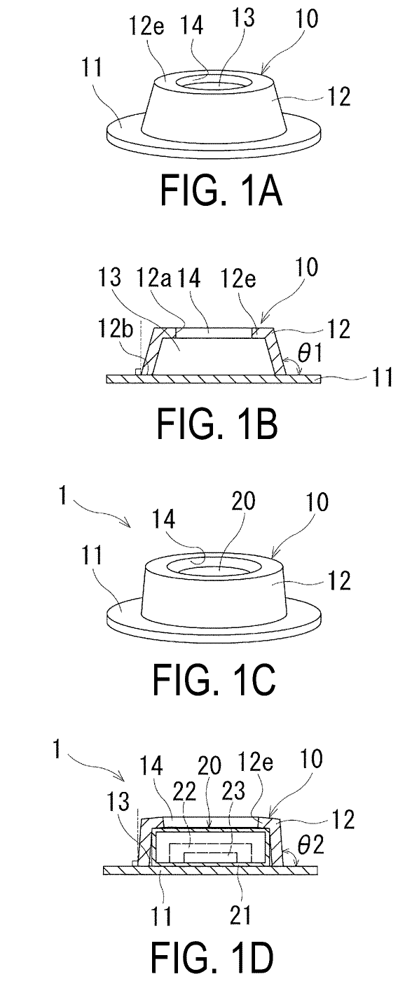

Hereinafter, embodiments of a housing body with a functional component of the present technology will be described in detail with reference to the accompanying drawings. A housing body with a functional component 1 illustrated in FIGS. 1A to 1D includes a functional component 20 configured to acquire tire information and a housing body 10 housing the functional component 20. The housing body with a functional component 1 in FIGS. 1A and 1B is in a state where the functional component 20 is not housed in the housing body 10, and the housing body with a functional component 1 in FIGS. 1C and 1D is in a state where the functional component 20 is housed in the housing body 10.

The housing body 10 includes a flat plate-shaped bottom portion 11 fixed to the tire inner surface, a cylindrical crown portion 12 protruding from the bottom portion 11, a housing space 13 formed by the bottom portion 11 and the crown portion 12, and an opening portion 14 communicating with the housing space 13.

The bottom portion 11 is the longest (and has the maximum diameter) among the portions constituting the housing body 10. The crown portion 12 is formed to be inclined inward from a direction orthogonal to the bottom portion 11. Accordingly, the housing space 13 formed by the bottom portion 11 and the crown portion 12 has a substantially trapezoidal cross-sectional shape. In other words, the cross-sectional width of the housing space 13 gradually decreases toward an upper portion and becomes smallest at the maximum height position. The crown portion 12 includes a locking portion 12e formed at one end 12a so as to be bent toward the opening portion 14, and the other end 12b is fixed to the bottom portion 11. After the functional component 20 is housed, the locking portion 12e is brought into contact with an upper surface of the functional component 20 and serves to fix the functional component 20 when the functional component 20 is housed. The width of the opening portion 14 into which the functional component 20 is inserted is smaller than the minimum width of the housing space 13 in a cross-sectional view (the width at a position adjacent to the opening portion 14).

In FIGS. 1A to 1D, each of the bottom portion 11, the crown portion 12, and the opening portion 14 has a circular planar shape and the housing space 13 has a truncated cone shape. The planar shapes of the bottom portion 11, the crown portion 12, and the opening portion 14 are not limited to a particular shape and may be any other planar shape or may be planar shapes different from each other. The shape of the housing space 13 is not limited to a particular shape, either.

As illustrated in FIG. 1D, the functional component 20 includes a housing 21 and an electronic component 22. The housing 21 has a hollow structure, and the electronic component 22 is housed therein. The electronic component 22 can include a sensor 23 configured to acquire tire information, a transmitter, a receiver, a control circuit, and a battery as appropriate. Examples of the tire information acquired by the sensor 23 include an internal temperature and an internal pressure of a pneumatic tire and the amount of wear of a tread portion. For example, a temperature sensor or a pressure sensor is used to measure internal temperature or internal pressure. In a case where the amount of wear of the tread portion is detected, a piezoelectric sensor including a piezoelectric element can be used as the sensor 23, and the piezoelectric element detects an output voltage corresponding to tire deformation during travel and detects the amount of wear of the tread portion in accordance with the output voltage. Moreover, an acceleration sensor or a magnetic sensor can also be used. The functional component 20 is configured to transmit the tire information acquired by the sensor 23 to the outside of the tire. Furthermore, to easily hold the functional component 20, a knob portion protruding from an upper surface of the housing 21 may be provided, and the knob portion can have a function of an antenna.

The internal structure of the functional component 20 illustrated in FIG. 1D is an example, and the internal structure is not limited to thereto. The sensor 23 may be fixed to the housing body 10 with an adhesive tape, an adhesive, or the like, or may not be fixed to the housing body 10.

In the aforementioned housing body with a functional component 1, an inclination angle θ2 of the crown portion 12 in a state where the functional component 20 is housed in the housing space 13 with respect to the bottom portion 11 is configured to be smaller than an inclination angle θ1 of the crown portion 12 in a state where the functional component 20 is not housed in the housing space 13 with respect to the bottom portion 11. Each of the inclination angles θ1 and θ2 is an angle measured on the outer wall side of the crown portion 12. When the functional component 20 is housed in the housing space 13 from the opening portion 14, the crown portion 12 flexes toward the outer side and deforms so as to expand the width of the opening portion 14, and thus the inclination angle θ of the crown portion 12 with respect to the bottom portion 11 decreases. The angle difference (θ1−θ2) between the inclination angle θ1 before the functional component 20 is housed and the inclination angle θ2 after the functional component 20 is housed is configured to be in the range of 5 to 15°.

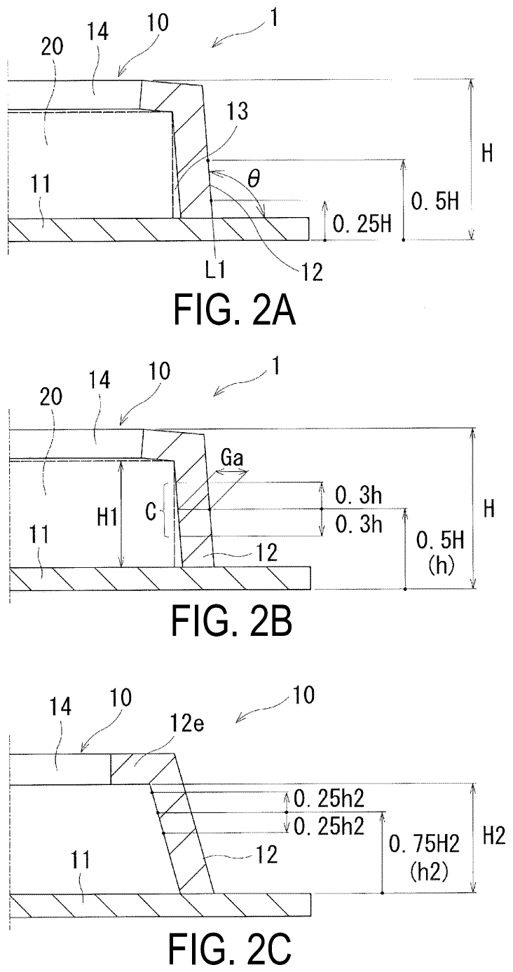

Here, in measuring the inclination angle θ (θ1, θ2) of the crown portion 12, the angle can be calculated by using a CT scan or the like. Only in measuring the inclination angle θ of the crown portion 12, as illustrated in FIG. 2A, the inclination angle θ1 before the functional component 20 is housed and the inclination angle θ2 after the functional component 20 is housed are respectively measured by regarding, as the crown portion 12, a straight line L1 passing through two points corresponding to one half of a total height H (0.5×H) and one quarter of the total height H (0.25×H) of the housing body 10 on the outer surface of the crown portion 12. The total height H (maximum height H) of the housing body 10 changes before and after the functional component 20 is housed, and the inclination angle θ (θ1, θ2) of the crown portion 12 is measured based on each height. When a projection is formed on the outer surface of the crown portion 12 at the position corresponding to one half and/or one quarter of the total height H of the housing body 10, the inclination angle θ of the crown portion 12 is measured based on a straight line defined by using a lower end portion of the projection as a new reference point without including the projection. The total height H of the housing body 10 is a height from a lower surface of the bottom portion 11 to an upper surface of the locking portion 12e.

The aforementioned housing body with a functional component is the housing body with a functional component that includes the functional component 20 configured to acquire tire information and the housing body 10 housing the functional component 20, the housing body 10 includes the bottom portion 11 fixed to the tire inner surface, the crown portion 12 protruding from the bottom portion 11, the housing space 13 formed by the bottom portion 11 and the crown portion 12, and the opening portion 14 communicating with the housing space 13, the inclination angle θ2 of the crown portion 12 measured on the outer wall side of the crown portion 12 in a state where the functional component 20 is housed in the housing space 13 with respect to the bottom portion 11 is smaller than the inclination angle θ1 of the crown portion 12 measured on the outer wall side of the crown portion 12 in a state where the functional component 20 is not housed in the housing space 13 with respect to the bottom portion 11. This can prevent, in the housing body 10 housing the functional component 20, excessive deformation of the housing body 10 while ensuring the restricting force by which the functional component 20 can be sufficiently restricted. In particular, when the angle difference (θ1−θ2) between the inclination angles before and after the functional component 20 is housed is in the range of 5 to 15°, the restricting force of the housing body 10 with respect to the functional component 20 and the degree of deformation at which the housing body 10 is not damaged is extremely well-balanced. This can prevent the damage of the housing body 10 while preventing the functional component 20 from coming off during travel.

Here, when the angle difference (θ1−θ2) of the inclination angles is smaller than 5°, the restricting force of the housing body 10 with respect to the functional component 20 is reduced. As a result, the risk of coming off of the functional component 20 during travel increases, the motion of the functional component 20 increases, and thus the durability of the housing body 10 is reduced. On the other hand, when the angle difference (θ1−θ2) between the inclination angles is larger than 15°, the deformation of the housing body 10 becomes excessively large, and cracks are likely to occur in the housing body 10 during long-distance travel.

In the aforementioned housing body with a functional component, the inclination angle θ2 of the crown portion 12 with respect to the bottom portion 11 in a state where the functional component 20 is housed in the housing space 13 is preferably 90° or more and more preferably in the range of 90° to 115°. Appropriately setting the inclination angle θ2 after the functional component 20 is housed as just described can mitigate stress concentration at the base of the crown portion 12 of the housing body 10 and improve the durability of the housing body 10. Moreover, the opening portion 14 of the housing body 10 is not excessively narrow, which is suitable for removing the functional component 20.

Here, when the inclination angle θ2 after the functional component 20 is housed is smaller than 90°, stress concentration at the base of the crown portion 12 of the housing body 10 increases, and strain energy during travel increases. As a result, cracks are likely to occur at the base of the crown portion 12. On the other hand, when the inclination angle θ2 after the functional component 20 is housed is larger than 115°, the crown portion 12 is excessively flexed even after the functional component 20 is housed. This makes the width of the opening portion 14 excessively narrow and makes it difficult to remove the functional component 20.

In a state where the functional component 20 is housed in the housing space 13, the crown portion 12 preferably has a thickness Ga of 1.0 mm to 3.5 mm. Here, as illustrated in FIG. 2B, a half height of the total height H of the housing body 10 after the functional component 20 is housed is h, and the range of 30% of the height h (0.3×h) with reference to the position (center position) of the height h is a central range C. At this time, in the entire central range C, the thickness Ga of the crown portion 12 measured in a horizontal direction is preferably in the range of 1.0 mm to 3.5 mm.

Appropriately setting the thickness Ga of the crown portion 12 as just described can suppress the occurrence of cracks in the crown portion 12 of the housing body 10 and improve the durability of the housing body 10. Furthermore, when the thickness Ga of the crown portion 12 of the housing body 10 is excessively large, the heat generation of the housing body 10 increases. However, when the thickness Ga is within the range described above, the heat generation of the housing body 10 can be suppressed, and damage of the housing 21 of the functional component 20 can be prevented.

Here, when the thickness Ga of the crown portion 12 is less than 1.0 mm, the thickness Ga of the crown portion 12 is excessively small, and cracks are likely to occur in the crown portion 12. On the other hand, when the thickness Ga of the crown portion 12 is larger than 3.5 mm, the heat generation of the housing body 10 (for example, rubber) increases, and the housing 21 of the functional component 20 is likely to be damaged.

The end 12a of the crown portion 12 preferably includes the locking portion 12e bent toward the opening portion 14, and the height H1 of the functional component 20 and the total inner height H2 of the housing body 10 preferably satisfy the relationship 0.85≤H2/H1≤0.98. Here, as illustrated in FIG. 2B, the height H1 of the functional component 20 is the maximum height within a range in which the functional component 20 is housed in the housing body 10 after the functional component 20 is housed, that is, the maximum height of the functional component 20 in the housing space 13. This means that when, for example, a knob portion disposed on an upper portion of the functional component 20 protrudes from the housing space 13, the height H1 of the functional component 20 does not include the height of a portion of the knob portion outside the housing space 13. The total inner height H2 of the housing body 10 is a height from an upper surface of the bottom portion 11 to a lower surface of the locking portion 12e before the functional component 20 is housed.

Appropriately setting the height H1 of the functional component 20 and the total inner height H2 of the housing body 10 as just described provides a good balance between the restricting force of the housing body 10 with respect to the functional component 20 and the degree of deformation at which the housing body 10 is not damaged and can improve the durability of the functional component 20 during high-speed travel.

Here, when the ratio H2/H1 is less than 0.85, the locking portion 12e cannot house the functional component 20 so as to cover the functional component 20, and thus the effect of improving the durability of the functional component 20 during high-speed travel is reduced. On the other hand, when the ratio H2/H1 is larger than 0.98, the restricting force of the housing body 10 decreases, and the motion of the functional component 20 in the housing body 10 increases. As a result, the effect of improving the durability of the functional component 20 during high-speed travel cannot be obtained.

The width of the opening portion 14 is preferably smaller than the minimum width of the housing space 13, and a circumferential length D2ᵤ of the upper portion of the housing space 13 and a circumferential length D1ᵤ of an upper portion of the functional component 20 preferably satisfy the relationship 0.60≤D2ᵤ/D1ᵤ≤0.95. In other words, the circumferential length D2ᵤ of the housing space 13 is set to be smaller than the circumferential length D1ᵤ of the functional component 20 within a specific range, and it is thereby intended to increase restricting force by the housing body 10. Here, as illustrated in FIG. 2C, the circumferential length D2ᵤ of the housing space 13 is obtained by defining a height of three quarters of the total inner height H2 (0.75×H2) of the housing body 10 as h2 before the functional component 20 is housed, measuring the circumferential length of the housing space 13 at a total of three positions including the position of the height h2 and the positions corresponding to ±25% of the height h2 (0.25×h2) with reference to the position of the height h2, and averaging the circumferential lengths measured at these three positions. The circumferential length D1ᵤ of the upper portion of the functional component 20 is obtained by measuring the circumferential length of the functional component 20 at positions corresponding to the aforementioned three positions of the functional component 20 and averaging the circumferential lengths measured at these three positions.

Appropriately setting the circumferential length D2ᵤ of the housing space 13 and the circumferential length D1ᵤ of the functional component 20 as just described can increase the restricting force of the housing body 10 with respect to the functional component 20 and suppress the motion of the functional component 20, thus allowing damage of the housing 21 of the functional component 20 to be prevented during high-speed travel. In addition, a good balance between the restricting force of the housing body 10 with respect to the functional component 20 and the degree of deformation at which the housing body 10 is not damaged is provided, and thus damage of the housing body 10 can also be prevented.

Here, when the ratio D2ᵤ/D1ᵤ is less than 0.60, the degree of deformation of the crown portion 12 also increases though the restricting force by the housing body 10 increases. As a result, cracks are generated in the housing body 10 during long-distance travel, and the possibility of damage of the housing body 10 increases. On the other hand, when the ratio D2ᵤ/D1ᵤ is larger than 0.95, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

Further, a circumferential length D2_{O} of the opening portion 14 of the housing body 10 and the circumferential length D1ᵤ of the upper portion of the functional component 20 preferably satisfy the relationship 0.4≤D2_{O}/D1ᵤ≤0.8. Here, the circumferential length D2_{O} of the opening portion 14 is a circumferential length of the opening portion 14 measured in a state where the functional component 20 is not housed in the housing body 10. Appropriately setting the circumferential length D2_{O} of the opening portion 14 and the circumferential length D1ᵤ of the functional component 20 as just described provides a good balance between the restricting force of the housing body 10 with respect to the functional component 20 and the degree of deformation at which the housing body 10 is not damaged and can improve durability of the functional component 20 during high-speed travel. Furthermore, the opening portion 14 of the housing body 10 is not excessively narrow, which is suitable for removing the functional component 20.

Here, when the ratio D2_{O}/D1ᵤ is less than 0.4, the opening portion 14 is excessively narrow, and thus it becomes difficult to remove the functional component 20. On the other hand, when the ratio D2_{O}/D1ᵤ is larger than 0.8, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

In the aforementioned housing body with a functional component, the housing body 10 can be made of rubber, elastomer, resin, or the like. The constituent material of the housing body 10 preferably has the following physical properties. The modulus of the housing body 10 at 100% elongation at 20° C. is preferably 0.5 MPa or more and less than 10.0 MPa, and the loss modulus of the housing body 10 at 60° C. is preferably 0.4 MPa or more and less than 20.0 MPa. Appropriately setting the modulus as just described can provide the durability of the housing body 10 and ease of housing the functional component 20 in the housing body 10 in a compatible manner. Appropriately setting the loss modulus as just described can prevent damage of the housing 21 of the functional component 20 due to rubbing of the functional component 20 against the housing body 10 or repeated deformation of the housing body 10.

Furthermore, the constituent material of the housing body 10 more preferably has the following physical properties. The elongation at break measured in accordance with JIS (Japanese Industrial Standard) K6251 is preferably 80% to 800% at 20° C. The tan S measured in accordance with JIS K6394 is preferably 0.04 to 0.40 at 60° C.

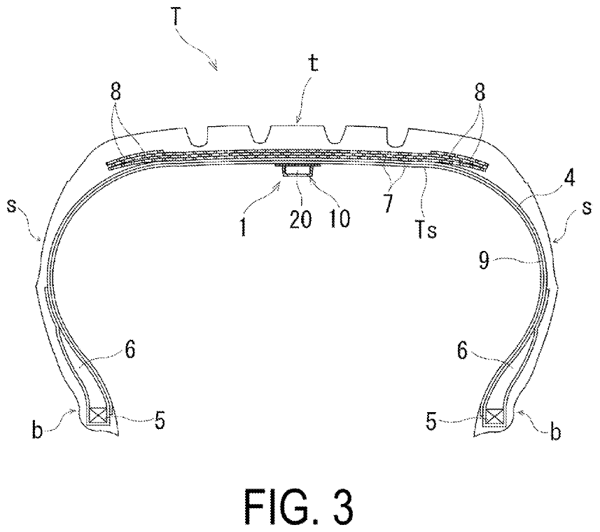

FIG. 3 illustrates a pneumatic tire in which the housing body with a functional component is fixed to the tire inner surface. As illustrated in FIG. 3, a pneumatic tire T includes a tread portion t extending in the tire circumferential direction and having an annular shape, a pair of sidewall portions s disposed on both sides of the tread portion t, and a pair of bead portions b each disposed on an inner side in the tire radial direction of the sidewall portions s.

A carcass layer 4 is mounted between the pair of bead portions b. The carcass layer 4 includes a plurality of reinforcing cords extending in the tire radial direction and is folded back around a bead core 5 disposed in each of the bead portions b from a tire inner side to a tire outer side. A bead filler 6 having a triangular cross-sectional shape and formed of a rubber composition is disposed on the outer circumference of the bead core 5. In addition, an innerliner layer 9 is disposed in an area between the pair of bead portions b on a tire inner surface Ts. The innerliner layer 9 forms the tire inner surface Ts.

Meanwhile, a plurality of belt layers 7 are embedded on the outer circumferential side of the carcass layer 4 in the tread portion t. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall in a range from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example of a pneumatic tire, but the pneumatic tire is not limited thereto.

In the pneumatic tire described above, at least one housing body with a functional component 1 is attached to the tire inner surface Ts. The housing body with a functional component 1 is fixed to the tire inner surface Ts with an adhesive. The adhesive preferably has a storage modulus at −40° C. in the range of 5.0×10⁸ Pa to 1.0×10¹⁰ Pa and a storage modulus at 150° C. in the range of 1.0×10⁶ Pa to 5.0×10⁷ Pa. Examples of the adhesive having such physical properties include instantaneous adhesives, epoxy-based adhesives, acrylic-based adhesives, rubber-based adhesives, and urethane-based adhesives. Appropriately setting the storage modulus of the adhesive as just described can prevent the housing body 10 from coming off due to repeated deformation or applied load applied during travel of the tire. The durability of the housing body 10 can be sufficiently ensured even when heat is generated during travel.

The housing body with a functional component 1 can be attached to any portion of the tire inner surface Ts. However, the housing body with a functional component 1 is preferably attached to the tire inner surface Ts corresponding, in particular, to the tread portion t of the tread portion t, the sidewall portions s, and the bead portions b because the housing body with a functional component 1 is less deformed during travel and is unlikely to come off due to centrifugal force applied thereto.

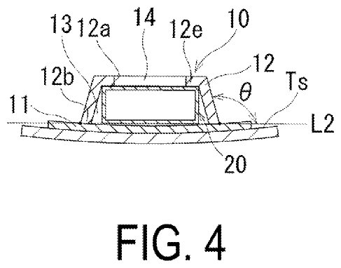

Here, as illustrated in FIG. 4, when the inclination angles θ1 and θ2 are measured in a state where the housing body with a functional component 1 is fixed to the tire inner surface, an angle formed by a straight line L2 passing through the other end 12b of both sides of the crown portion 12 in a cross-sectional view and the crown portion 12 is measured. For example, even a housing body with a functional component that is not provided with a member corresponding to a bottom portion and is provided with a crown portion directly fixed to the tire inner surface can be measured by the same method as described above.

In the aforementioned embodiment, an example in which the housing body with a functional component is attached to the pneumatic tire is described but no such limitation is intended, and the housing body with a functional component can be applied to a non-pneumatic tire.

### Examples

Tires of Conventional Examples 1 and 2 and Examples 1 to 23 were manufactured. Each of the tires has a tire size of 225/45ZR18 and includes a functional component configured to acquire tire information and a housing body housing the functional component. The housing body includes a bottom portion fixed to the tire inner surface, a crown portion protruding from the bottom portion, a housing space formed by the bottom portion and the crown portion, and an opening portion communicating with the housing space. A housing body with a functional component in which the functional component is housed in the housing body is fixed to the tire inner surface. The inclination angle θ1 of the crown portion before housing, the inclination angle θ2 of the crown portion after housing, the angle difference (θ1−θ2) between the inclination angles before and after housing, the thickness Ga of the crown portion, the ratio D2ᵤ/D1ᵤ, the ratio H2/H1, and the ratio D2_{O}/D1ᵤ were set as indicated in Tables 1 and 2.

The presence of coming-off, removability, and high-speed durability of the functional component were evaluated for the test tires by the following test methods, and the cracking resistance and durability of the housing body were evaluated. The results are also indicated in Tables 1 and 2.

### Presence of Coming-Off (Functional Component):

Each of the test tires was mounted on a wheel having a rim size of 18×7½JJ, an 88% load of the maximum load under air pressure of 200 kPa was applied, and a running test was performed on the tire using a drum testing machine at temperature of −20° C., under air pressure of 160 kPa, and at running speed of 81 km. Specifically, leaving the tire to stand for a certain period of time to cool the tire after running under the above conditions is defined as one cycle. After 50 cycles were performed, it was visually confirmed whether the functional component had come off. The evaluation results indicated the presence of coming-off of the functional component.

### Removability (Functional Component)

For the housing body with a functional component of each test tire, the operation of removing the functional component inserted into the housing body was repeated 10 times, and the time required for each removing operation was measured. The evaluation results are indicated in three stages: “⊚ (excellent)” when the required time for each of the 10 times operations was within 20 seconds, “∘ (good)” when the required time for each of the 10 times operations was more than 20 seconds and within 60 seconds, and “x (poor)” when the required time for each of the 10 times operations was more than 60 seconds.

### High-Speed Durability (Functional Component):

Each of the test tires was mounted on a wheel having a rim size of 18×7½JJ, an 88% load of the maximum load capacity was applied, and a running test was performed on the tire using a drum testing machine under the condition of air pressure of 360 kPa. Specifically, the speed was increased from an initial speed of 120 km/h by 10 km/h every ten minutes, the tires were run until a housing of the functional component was damaged, and running distances were measured. Evaluation results are expressed as index values with Conventional Example 1 being assigned the index value of 100. Larger index values indicate superior high-speed durability.

### Cracking Resistance (Housing Body):

Each of the test tires was mounted on a wheel having a rim size of 18×7½JJ, an 80% load of the maximum load capacity was applied after deterioration treatment was performed in the presence of oxygen at 80° C. for five days, and a running test was performed on the tire using a drum testing machine under the condition of air pressure of 250 kPa. Specifically, the speed was increased from an initial speed of 120 km/h by 10 km/h every 24 hours, the tires were run until the speed reached 170 km/h, and then the occurrence of cracks or wrinkles in the housing body was visually confirmed. The evaluation results were indicated in three levels: “⊚ (excellent)” when there were no cracks and wrinkles, “∘ (good)” when there were only wrinkles, and “x (poor)” when there were cracks.

### Durability (Housing Body):

Each of the test tires was mounted on a wheel having a rim size of 18×7½JJ, and a running test was performed on the tire using a drum testing machine at air pressure of 540 kPa, 160% with respect to the maximum load, running speed of 81 km/h, and a running distance of 20000 km. Thereafter, the occurrence of damage of the housing body and cracks therein was visually confirmed, and the total number of occurrence locations was measured. The evaluation results are expressed as index values using the reciprocal of the measurement values, with Conventional Example 1 being assigned the index value of 100. Larger index values indicate superior durability.

TABLE 1-1

| | | Conventional | Conventional | Example | Example |
|---|---|---|---|---|---|
| | | Example 1 | Example 2 | 1 | 2 |
| Inclination angle θ1 of crown | | 95° | 105° | 90° | 95° |
| portion before housing | | | | | |
| Inclination angle θ2 of crown | | 95° | 85° | 85° | 85° |
| portion after housing | | | | | |
| Angle difference between inclination | | 0° | 20° | 5° | 10° |
| angles before and after housing (θ1 − θ2) | | | | | |
| Thickness Ga of crown portion (mm) | | 0.5 | 0.5 | 0.5 | 0.5 |
| Ratio D2ᵤ/D1ᵤ | | 0.50 | 0.50 | 0.50 | 0.50 |
| Ratio H2/H1 | | 0.80 | 0.80 | 0.80 | 0.80 |
| Ratio D2_{∘}/D1ᵤ | | 0.3 | 0.3 | 0.3 | 0.3 |
| Functional | Presence of coming-off | Yes | No | No | No |
| component | Removability | ∘ | ∘ | ∘ | ∘ |
| | High-speed durability | 100 | 101 | 115 | 115 |
| Housing | Cracking resistance | ∘ | x | ∘ | ∘ |
| body | Durability | 100 | 101 | 101 | 101 |

TABLE 1-2

| | | Example | Example | Example | Example | Example |
|---|---|---|---|---|---|---|
| | | 3 | 4 | 5 | 6 | 7 |
| Inclination angle θ1 of crown portion | | 100° | 100° | 105° | 125° | 130° |
| before housing | | | | | | |
| Inclination angle θ2 of crown portion | | 85° | 90° | 95° | 115° | 120° |
| after housing | | | | | | |
| Angle difference between inclination | | 15° | 10° | 10° | 10° | 10° |
| angles before and after housing (θ1 − θ2) | | | | | | |
| Thickness Ga of crown portion (mm) | | 0.5 | 0.5 | 0.5 | 0.5 | 0.5 |
| Ratio D2ᵤ/D1ᵤ | | 0.50 | 0.50 | 0.50 | 0.50 | 0.50 |
| Ratio H2/H1 | | 0.80 | 0.80 | 0.80 | 0.80 | 0.80 |
| Ratio D2_{∘}/D1ᵤ | | 0.3 | 0.3 | 0.3 | 0.3 | 0.3 |
| Functional | Presence of coming-off | No | No | No | No | No |
| component | Removability | ∘ | ∘ | ∘ | ∘ | x |
| | High-speed durability | 115 | 115 | 115 | 115 | 115 |
| Housing body | Cracking resistance | ∘ | ∘ | ∘ | ∘ | ∘ |
| | Durability | 101 | 103 | 103 | 103 | 103 |

TABLE 1-3

| | | Example | Example | Example | Example |
|---|---|---|---|---|---|
| | | 8 | 9 | 10 | 11 |
| Inclination angle θ1 of crown | | 105° | 105° | 105° | 105° |
| portion before housing | | | | | |
| Inclination angle θ2 of crown | | 95° | 95° | 95° | 95° |
| portion after housing | | | | | |
| Angle difference between inclination | | 10° | 10° | 10° | 10° |
| angles before and after housing (θ1 − θ2) | | | | | |
| Thickness Ga of crown portion (mm) | | 1.0 | 2.5 | 3.5 | 4.0 |
| Ratio D2ᵤ/D1ᵤ | | 0.50 | 0.50 | 0.50 | 0.50 |
| Ratio H2/H1 | | 0.80 | 0.80 | 0.80 | 0.80 |
| Ratio D2_{∘}/D1ᵤ | | 0.3 | 0.3 | 0.3 | 0.3 |
| Functional | Presence of coming-off | No | No | No | No |
| component | Removability | ∘ | ∘ | ∘ | ∘ |
| | High-speed durability | 115 | 115 | 115 | 102 |
| Housing body | Cracking resistance | ∘ | ∘ | ∘ | ∘ |
| | Durability | 105 | 105 | 105 | 105 |

TABLE 2-1

| | | Example | Example | Example | Example |
|---|---|---|---|---|---|
| | | 12 | 13 | 14 | 15 |
| Inclination angle θ1 of crown | | 105° | 105° | 105° | 105° |
| portion before housing | | | | | |
| Inclination angle θ2 of crown | | 95° | 95° | 95° | 95° |
| portion after housing | | | | | |
| Angle difference between inclination | | 10° | 10° | 10° | 10° |
| angles before and after housing (θ1 − θ2) | | | | | |
| Thickness Ga of crown portion (mm) | | 2.5 | 2.5 | 2.5 | 2.5 |
| Ratio D2ᵤ/D1ᵤ | | 0.60 | 0.95 | 1.00 | 0.80 |
| Ratio H2/H1 | | 0.80 | 0.80 | 0.80 | 0.80 |
| Ratio D2_{∘}/D1ᵤ | | 0.3 | 0.3 | 0.3 | 0.3 |
| Functional | Presence of coming-off | No | No | No | No |
| component | Removability | ◯ | ◯ | ◯ | ◯ |
| | High-speed durability | 115 | 115 | 110 | 115 |
| Housing body | Cracking resistance | ⊚ | ⊚ | ⊚ | ⊚ |
| | Durability | 105 | 105 | 105 | 105 |

TABLE 2-2

| | | Example | Example | Example | Example |
|---|---|---|---|---|---|
| | | 16 | 17 | 18 | 19 |
| Inclination angle θ1 of crown | | 105° | 105° | 105° | 105° |
| portion before housing | | | | | |
| Inclination angle θ2 of crown | | 95° | 95° | 95° | 95° |
| portion after housing | | | | | |
| Angle difference between inclination | | 10° | 10° | 10° | 10° |
| angles before and after housing (θ1 − θ2) | | | | | |
| Thickness Ga of crown portion (mm) | | 2.5 | 2.5 | 2.5 | 2.5 |
| Ratio D2ᵤ/D1ᵤ | | 0.80 | 0.80 | 0.80 | 0.80 |
| Ratio H2/H1 | | 0.85 | 0.98 | 1.00 | 0.90 |
| Ratio D2_{∘}/D1ᵤ | | 0.3 | 0.3 | 0.3 | 0.3 |
| Functional | Presence of coming-off | No | No | No | No |
| component | Removability | ◯ | ◯ | ◯ | ◯ |
| | High-speed durability | 120 | 120 | 115 | 128 |
| Housing | Cracking resistance | ⊚ | ⊚ | ⊚ | ⊚ |
| body | Durability | 105 | 105 | 105 | 105 |

TABLE 2-3

| | | Example | Example | Example | Example |
|---|---|---|---|---|---|
| | | 20 | 21 | 22 | 23 |
| Inclination angle θ1 of crown | | 105° | 105° | 105° | 105° |
| portion before housing | | | | | |
| Inclination angle θ2 of crown | | 95° | 95° | 95° | 95° |
| portion after housing | | | | | |
| Angle difference between inclination | | 10° | 10° | 10° | 10° |
| angles before and after housing (θ1 − θ2) | | | | | |
| Thickness Ga of crown portion (mm) | | 2.5 | 2.5 | 2.5 | 2.5 |
| Ratio D2ᵤ/D1ᵤ | | 0.80 | 0.80 | 0.80 | 0.80 |
| Ratio H2/H1 | | 0.90 | 0.90 | 0.90 | 0.90 |
| Ratio D2_{∘}/D1ᵤ | | 0.4 | 0.6 | 0.8 | 0.9 |
| Functional | Presence of coming-off | No | No | No | No |
| component | Removability | ⊚ | ⊚ | ⊚ | ⊚ |
| | High-speed durability | 128 | 126 | 124 | 120 |
| Housing | Cracking resistance | ⊚ | ⊚ | ⊚ | ⊚ |
| body | Durability | 105 | 105 | 105 | 105 |

As can be seen from Tables 1 and 2, the pneumatic tires of Examples 1 to 23 have improved the presence of coming-off of the functional component and cracking resistance of the housing body as compared to those of Conventional Example 1. In particular, the pneumatic tires of Examples 20 to 23 have improved removability of the functional component as compared to that of Conventional Example 1. The pneumatic tires of Examples 1 to 23 have improved high-speed durability of the functional component and durability of the housing body as compared to those of Conventional Example 1.

On the other hand, in Conventional Example 2, since the angle difference (θ1−θ2) between the inclination angles before and after housing was large, the functional component did not come off, but the cracking resistance of the housing body deteriorated.

1. A housing body with a functional component, the housing body comprising:
a functional component configured to acquire tire information; and
a housing body housing the functional component;
the housing body comprising a bottom portion fixed to a tire inner surface, a crown portion protruding from the bottom portion, a housing space formed by the bottom portion and the crown portion, and an opening portion communicating with the housing space,
an inclination angle of the crown portion measured on an outer wall side of the crown portion in a state where the functional component is housed in the housing space with respect to the bottom portion being smaller than an inclination angle of the crown portion measured on the outer wall side of the crown portion in a state where the functional component is not housed in the housing space with respect to the bottom portion, and
an angle difference between the inclination angles being in a range of 5° to 15°.

2. The housing body with a functional component according to claim 1, wherein the inclination angle of the crown portion measured on the outer wall side of the crown portion in a state where the functional component is housed in the housing space with respect to the bottom portion is 90° or more.

3. The housing body with a functional component according to claim 1, wherein the crown portion in which the functional component is housed in the housing space has a thickness Ga of 1.0 mm to 3.5 mm.

4. The housing body with a functional component according to claim 1, wherein
the opening portion has a width smaller than a minimum width of the housing space, and
a circumferential length D2ᵤ of an upper portion of the housing space and a circumferential length D1ᵤ of an upper portion of the functional component satisfy a relationship 0.60≤D2ᵤ/D1ᵤ≤0.95.

5. The housing body with a functional component according to claim 1, wherein
an end portion of the crown portion comprises a locking portion bent toward the opening portion, and
a height H1 of the functional component and a total inner height H2 of the housing body satisfy a relationship 0.85≤H2/H1≤0.98.

6. The housing body with a functional component according to claim 1, wherein a circumferential length D2_{O} of the opening portion of the housing body and a circumferential length D1ᵤ of an upper portion of the functional component satisfy a relationship 0.4≤D2_{O}/D1ᵤ≤0.8.

7. The housing body with a functional component according to claim 1, wherein
a modulus of the housing body at 100% elongation at 20° C. is 0.5 MPa or more and less than 10.0 MPa, and
a loss modulus of the housing body at 60° C. is 0.4 MPa or more and less than 20.0 MPa.

8. The housing body with a functional component according to claim 1, wherein the housing body is made of vulcanized rubber.

9. The housing body with a functional component according to claim 1, wherein the housing body is fixed to the tire inner surface with an adhesive.

10. A tire, comprising
the housing body with a functional component according to claim 1 fixed to the tire inner surface,
the functional component being housed in the housing space.

11. The housing body with a functional component according to claim 2, wherein the crown portion in which the functional component is housed in the housing space has a thickness Ga of 1.0 mm to 3.5 mm.

12. The housing body with a functional component according to claim 11, wherein
the opening portion has a width smaller than a minimum width of the housing space, and
a circumferential length D2ᵤ of an upper portion of the housing space and a circumferential length D1ᵤ of an upper portion of the functional component satisfy a relationship 0.60≤D2ᵤ/D1ᵤ≤0.95.

13. The housing body with a functional component according to claim 12, wherein
an end portion of the crown portion comprises a locking portion bent toward the opening portion, and
a height H1 of the functional component and a total inner height H2 of the housing body satisfy a relationship 0.85≤H2/H1≤0.98.

14. The housing body with a functional component according to claim 13, wherein a circumferential length D2_{O} of the opening portion of the housing body and a circumferential length D1ᵤ of an upper portion of the functional component satisfy a relationship 0.4≤D2_{O}/D1ᵤ≤0.8.

15. The housing body with a functional component according to claim 14, wherein
a modulus of the housing body at 100% elongation at 20° C. is 0.5 MPa or more and less than 10.0 MPa, and
a loss modulus of the housing body at 60° C. is 0.4 MPa or more and less than 20.0 MPa.

16. The housing body with a functional component according to claim 15, wherein the housing body is made of vulcanized rubber.

17. The housing body with a functional component according to claim 16, wherein the housing body is fixed to the tire inner surface with an adhesive.

18. A tire, comprising
the housing body with a functional component according to claim 17 fixed to the tire inner surface,
the functional component being housed in the housing space.
